(19) United States
(12) Patent Application Publication
(10) Pub. No.: US 2026/0000487 A1
(43) Pub. Date: Jan. 1, 2026

(54) SYSTEMS, APPARATUS, AND METHODS FOR FABRICATING DENTAL APPLIANCES WITH STACKABLE FEATURES

(71) Applicant: ALIGN TECHNOLOGY, INC., San Jose, CA (US)

(72) Inventors: Jun Sato, San Jose, CA (US); James Nishimuta, Durham, NC (US); Eric Yau, Santa Clara, CA (US); Ken Wu, San Jose, CA (US)

(21) Appl. No.: 19/252,034

(22) Filed: Jun. 27, 2025

Related U.S. Application Data
(60) Provisional application No. 63/666,207, filed on Jun. 30, 2024.

(51) Int. Cl. A61C 7/08; A61C 7/00; A61C 7/16

(52) U.S. Cl. CPC A61C 7/08; A61C 7/002; A61C 7/16

(57) ABSTRACT

An orthodontic appliance may include a polymeric shell and a plurality of tooth receiving cavities formed in the polymeric shell that are shaped to move the teeth from a first arrangement towards a second arrangement. A first aligner feature may be located at a first location on a first of the tooth receiving cavities. The first aligner feature may be a force generating feature configured to impart orthodontic tooth moving forces. A second aligner feature may be stacked onto the first aligner feature at the first location on the first of the tooth receiving cavities.

### RELATED APPLICATIONS

This application claims the benefit under 35 U.S.C. § 119 (e) of U.S. Provisional Patent Application No. 63/666,207, filed Jun. 30, 2024, and titled “SYSTEMS, APPARATUS, AND METHODS FABRICATING DENTAL APPLIANCES WITH STACKABLE FEATURES,” which is incorporated, in its entirety, by this reference.

### BACKGROUND

Dental treatments may involve procedures for repositioning misaligned teeth and changing bite configurations for improved cosmetic appearance and/or dental function. Repositioning can be accomplished, for example, by applying controlled forces over a period of time to one or more teeth and/or the jaw.

Orthodontic repositioning of teeth may be achieved through the use of orthodontic repositioning appliances. Such appliances may utilize a thin shell of material having resilient properties, referred to as an “aligner,” that generally conforms to a patient's teeth and applies tooth repositions forces to incrementally repositions the patient's teeth.

Placement of such an appliance over the teeth may provide controlled forces in specific locations to gradually move the teeth into a new configuration. Repetition of this process with successive appliances can move the teeth through a series of intermediate arrangements towards a final arrangement.

In various instances, teeth of a patient's upper jaw and teeth of the patient's lower jaw may contact in an incorrect or suboptimal manner (e.g., due to crowding, crossbite, deep bite). A proper fit of the occlusal surfaces of the teeth is helpful for proper biting and chewing, as well as desirable for aesthetic appearance. Otherwise, premature wear of the teeth, undesirable flexion of the teeth, and/or undesirable forces on dental restorations may be experienced by the patient. For instance, a proper fit of the occlusal surfaces of the teeth can be a function of the relative positions of teeth and the mandible and maxilla. The maxilla (e.g., the upper jaw) is a bone that is fixed to the skull. The mandible (e.g., lower jaw) is a bone that is attached to the skull by numerous muscles which guide its movement. The mandible articulates at its posterior upward extremities with the temporal bone to form the jaw joint. The jaw joint is a loosely connected joint that accommodates the variety of movements of the mandible relative to the maxilla during biting and chewing motions. The numerous muscles attaching the mandible to the skull control and power the complex movements involved in biting and chewing. Because the condylar relationship affords some flexibility in the positioning of the jaw, the lower jaw can be intentionally repositioned in accordance with the fit of the teeth, for instance, by using an oral appliance.

In various instances, a tooth may be subject to more than one type of movement or treatment. As one example, a patient may be treated with mandibular adjustments along with orthodontic adjustments of a tooth using attachments on which an occlusal block or buccal wing may be located. Prior approaches to mandibular repositioning can be less than ideal in at least some respects. For example, an orthodontic aligner, such as a thermoformed aligner may not be able to apply orthodontic movement forces to an attachment while also having an occlusal block or buccal wing located on an aligner at that tooth location.

In light of the above, improved orthodontic devices that overcome at least some of the above limitations of the prior devices would be helpful.

### SUMMARY

The present disclosure is generally related to the design and fabrication of dental appliances having stackable or stacked features for use in treating malocclusions with oral appliances, such as for mandibular relocation. Embodiments of the present disclosure provide improved oral appliances for mandibular relocation with improved engagement that can allow for improved fabrication processes and resilience to plastic deformation and crushing or collapsing under occlusal forces.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 depicts an aligner having two stacked features, namely a bite ramp and an attachment receiving cavity, on a lingual side of a tooth receiving cavity, in accordance with some embodiments;

FIG. 2 depicts an aligner having two stacked features, namely a buccal wing and a protrusion, on a buccal side of a tooth receiving cavity, in accordance with some embodiments;

FIG. 3A depicts views of an aligner having two stacked features, namely a buccal wing and protrusions on lingual and buccal sides of a tooth receiving cavity, in accordance with some embodiments;

FIG. 3B depicts views of an aligner having two stacked features, namely a buccal wing and protrusions on mesial and distal sides of a tooth receiving cavity, in accordance with some embodiments;

FIG. 4 depicts an aligner having two stacked features, namely a buccal wing and an attachment receiving cavity, on a buccal side of a tooth receiving cavity, in accordance with some embodiments;

FIG. 5 depicts an aligner having two stacked features, namely compliance indicator and an attachment receiving cavity, on a sidewall of a tooth receiving cavity, in accordance with some embodiments;

FIG. 6 depicts an aligner having two stacked features, namely a button and an attachment receiving cavity, on a sidewall of a tooth receiving cavity, in accordance with some embodiments;

FIG. 7 depicts a process of fabricating a multi-layer thermoformed aligner having two stacked features, namely a buccal wing and an attachment receiving cavity, on a sidewall of a tooth receiving cavity, in accordance with some embodiments;

FIGS. 8A and 8B depict views of an aligner having two stacked features, namely a power arm and an attachment receiving cavity, on a sidewall of a tooth receiving cavity, in accordance with some embodiments;

FIG. 9 depicts a process for designing and fabricating an aligner having stacked features;

FIG. 10 depicts a simplified block diagram of a orthodontic aligner design and fabrication system, in accordance with some embodiments;

FIG. 11 depicts a tooth repositioning appliance, in accordance with some embodiments;

FIG. 12 depicts a tooth repositioning system, in accordance with some embodiments;

FIG. 13 depicts a method of orthodontic treatment using a plurality of appliances, in accordance with some embodiments; and

FIG. 14 depicts views of an aligner having stacked features, namely an occlusal block and protrusions on the occlusal surfaces of a tooth receiving cavity, in accordance with some embodiments.

### DETAILED DESCRIPTION

The following detailed description provides a better understanding of the features and advantages of the systems, apparatus, and methods described in the present disclosure in accordance with the embodiments disclosed herein. Although the detailed description includes many specific embodiments, these are provided by way of example only and should not be construed as limiting the scope of the inventions disclosed herein.

The systems, methods, apparatus, oral appliances, and stacked features disclosed herein are well suited for combination with prior devices such as aligners to reposition teeth, for example the Invisalign system commercially available from Align Technology, Inc. For example, a plurality of appliances can be sequentially placed on a patient's dentition to elicit tooth and/or movement jaw movement over incremental sequential stages of orthodontic treatment including movement of teeth having mandibular features, occlusal block and wings, and movement of teeth using multiple stacked features simultaneously, such as during the same stages of treatment.

The stacked features are well suited for easy design and manufacturing of aligners having stacked features with varying geometries, including various sizes and shapes to account for changes in the patient's dentition and jaw during treatment.

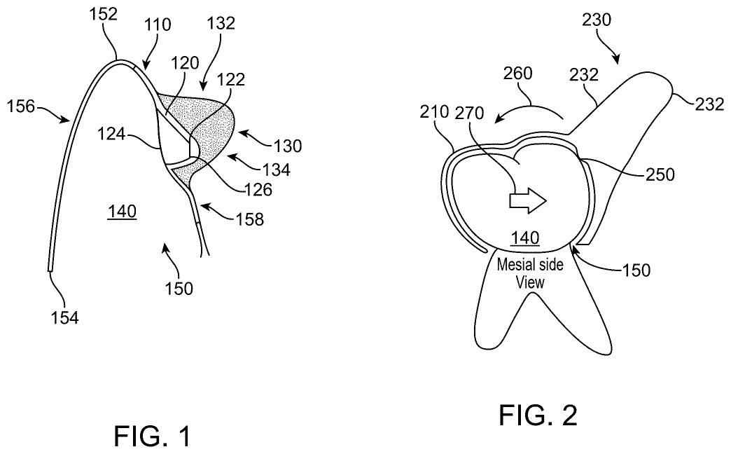

FIG. 1 depicts an aligner 110 applied to a tooth 140 and having two stacked features, namely a bite ramp 130 and an attachment receiving cavity 122, on a lingual side of a tooth receiving cavity 150. The tooth receiving cavity 150 may have a shape and contour of the tooth it is designed to fit. It may over the crown of the tooth, from the biting surface 152, e.g. an incisal or occlusal surface, down to the gingiva or cut line 154. The tooth receiving cavity and the aligner may include the biting surface or wall 152, a buccal sidewall 156, and a lingual sidewall 158. The shape and contour of the tooth receiving cavity may be designed using digital scans and 3D modeling of the patient's teeth so that the aligner not only fits well but also functions effectively by applying the correct amount of orthodontic tooth moving forces to move the tooth gradually over one or more stages of treatment. The sidewalls of the tooth receiving cavity may have a tooth facing or tooth contact surface which may be the inner surface of the cavity and an outer surface which may be an outward facing surface of the aligner 110.

In some embodiments, a dental positioning appliance (e.g., aligner) may include a bite ramp 130 positioned thereon for one or more stages of treatment. For example, the bite ramps can be placed according to a stage of treatment associated with the appliance. One, several, or all of a series of appliances can include bite ramps that are positioned with a shape and location that is specific to a respective stage of a treatment plan associated with each appliance. In some embodiments, the bite ramps can be formed of a same material as the appliance and/or formed at a same time as the appliance.

The appliance 110 can include a plurality of bite ramps 130 each on a respective tooth receiving cavity of an appliance. The bite ramps 130 are formed with the same material as the appliance shell, such as in a continuous body.

The bite ramps 130 can extend from a lingual surface of the appliance 110 in a lingual direction. E.g., on incisal teeth toward the back of the mouth, in a facial-lingual direction, and be designed to interface with teeth of the jaw opposing the jaw over which the appliance 110 is configured to be worn. For example, the appliance 110 can be designed to fit over teeth in a user's upper jaw and the bite ramps 130 can be designed to interface with teeth of the user's lower jaw. The shape, including the size, contours, angles, etc. and location, e.g., position on the cavity, of each of the bite ramps 130 may be specific to a stage of a treatment plan for which the appliance 110 was designed. For example, successive appliances created according to a treatment plan may have differently shaped and/or located bite ramps 130. A particular bite ramp 130 may have a shape and location specific to a particular stage of the treatment plan based on at least one of an interface with a particular tooth of an opposing jaw, an intended use, and an orientation of a tooth over which the bite ramp 130 is configured to be positioned.

Bite ramps on the upper appliance can be designed to interface with teeth of the lower jaw and the bite ramps on the lower appliance can be designed to interface with teeth of the upper jaw. For example a bite ramp may be configured to interface with teeth of an opposing jaw that are or are not covered by another appliance.

The bite ramps 130 can be designed to provide a disocclusion between opposing jaws. Providing a disocclusion between opposing jaws can allow for adjustment of a vertical relationship between the upper and lower jaws. Disocclusion may also reduce or preclude occlusal forces on posterior teeth to allow for orthodontic movement without occlusal forces interfering with tooth movements. That is, the bite ramps 130 can be designed and intended for adjustment of the vertical relationship between upper and lower jaws and/or a vertical relationship between respective teeth in the upper and lower jaws. In some embodiments, the appliance 110 may be designed to reposition a number of teeth 140 over which the appliance 110 is worn while the bite ramps 130 provide a disocclusion between opposing jaws. Providing a disocclusion between opposing jaws can help prevent appliances on opposing jaws from interacting, such as by touching and exertion of forces between each other.

Providing a disocclusion between opposing jaws can adjust an occlusal plane of the user. Such an adjustment can be temporary, such as while the appliance 110 is worn and/or permanent. For example, the bite ramps 106 can be designed to provide a disocclusion between opposing posterior teeth when the user bites so that the teeth do not bind with and/or contact each other.

The bite ramp 130 is illustrated on a lingual side of the cavity 150. The bite ramp 130 may have a first surface 132 extending away from the cavity 150 proximal to a biting surface 152 of the cavity 150. The first surface may be a surface configured to contact or receive the teeth of the opposing jaw, as discussed herein. The bite ramp 130 may have a second surface 134. The second surface 134 can extend in a generally biting (incisal) direction relative to the front-to-back (facial-lingual) direction in which the first surface 132 extends. The second surface 134 can extend from a location where the cavity 150 is shaped to mate with a tooth received therein.

An angle 117 between the first surface 132 of the bite ramp 130 and a plane 118 parallel to occlusal plane of the patient is illustrated. The angle 117 may be a slope in a buccal lingual direction. The surface may also have an angle between the first surface 132 and the occlusal plane 118, in a mesial distal direction. According to some embodiments of the present disclosure, different cavities can have different angles between the first surface 132 and the occlusal plane 117. Having different angles between different bite ramps and the occlusal plane can allow for more accurate modeling and application of forces applied to the bite ramps by opposing teeth of the user. Having different angles between different bite ramps and the occlusal plane can allow for more accurate control of a direction in which force is to be applied to each of the bite ramps by opposing teeth of the user, for example, in a situation where a treatment plan for a user calls for repositioning a tooth within the cavity in a direction other than directly toward the root and/or jaw, such as, for example, to correct for a tooth with undesirable inclination or reclination.

These appliances function by applying force to specific surfaces of the teeth or dental features to cause directed movement. However, the type of movement and level of force applied is usually dependent on the surface characteristics and positions of the dental features. In many cases, the native tooth surface(s) and other dental features of a patient are inadequate to provide sufficient anchoring or to impart sufficient force on the teeth to be repositioned. To overcome these limitations, one or more attachment devices which may be attached to preselected attachment points on the teeth or dental features to provide the appropriate physical leverage. Specific design and location of these attachment devices may be determined based on the movements of the treatment plan and may provide greater repositioning forces, anchoring ability, and appliance retention as compared to a tooth without an attachment, such as the ability to extrude, rotate, and otherwise manipulate teeth.

Attachment devices may be formed and/or bonded to the surface of the teeth in order to provide physical features which facilitate the application of controlled force. The attachment devices may have a base 124 on a body 126 having a shape, such as a bump, bead, wedge, or other body or structure which can be fixedly attached to the surface of a tooth or other dental feature in order to transmit forces generated by the dental positioning appliance to the dental feature and/or to anchor the positioning appliance to teeth in order to permit the appliance to apply forces elsewhere in the patient's teeth. In such embodiments, the attachment device may act to assist in the transmission of force between the teeth and the dental positioning appliance.

The attachment devices may have a base 124 and a body 126 may protrude up to 3 mm from the surface of the tooth. The attachment devices may be bonded in specific locations throughout the dentition where appropriate based on the treatment plan. The attachment device may be bonded to any surface of the tooth, including lingual surfaces, buccal surfaces, or biting surfaces.

The attachment body 126 may feature a variety of designs, such as bumps, beads, wedges, also including but not limited to hooks, clasps, bands, brackets, buttons, snaps, springs, levers, rods, tubes, coils, indents and/or other protrusions. Each design may serve one or a number of purposes in repositioning of the teeth. For example, a clasp may be used to attach a portion of a removable positioning appliance to the attachment device. This attachment device design may be desired for anchoring of the appliance or applying force to the dental feature to which the attachment device is bonded. Additional devices may be used in conjunction with the attachment body to attach the appliance to the attachment device. For example, adhesives, flexible bands or connecting ligatures may be used in conjunction with the design of the attachment body to aid in connection to the appliance. In some embodiments, the attachment body may be shaped with features to aid in properly seating a removable elastic repositioning appliance, in addition to anchoring the appliance in place to apply repositioning forces, such as with a sloping face e.g., a wedge.

The attachment device 120 is shown bonded to a crown of a tooth 140 above the gingiva. The attachment device 120 may be comprised of an attachment body 126 having a base 124. The base 124 may be a surface of the attachment body 120 for direct bonding to the tooth 140. The outer surface of the attachment body 126 may be shaped to engage with and/or may be received within received within an attachment receiving well 122 of the aligner 110. The exterior surface contours or shape of the body of the attachment may match the interior contours or shape of the attachment receiving well 122. In some embodiments, the attachment device 120 and the attachment receiving well may have different shapes such that only a portion of the exterior surface of the body 126 of the attachment device 120 comes into contact with only a portion of the interior surface of the attachment receiving well 122.

As shown in FIG. 1, the bite ramp 130 and the attachment receiving well of the appliance are stacked in the same location on the tooth receiving cavity of the appliance 110. With a conventional thermoformed appliance the bite ramp may be formed having an interior cavity having the same shape as the as the external shape of the bite ramp. Such a shape would prevent the use of an attachment 120 in the same location as the bite ramp 130. However, through the use of other fabrication techniques such as direct fabrication, the body of the bite ramp 130 may be solid or include support structures or infill which allows the bite ramp 130 to accommodate an attachment receiving well 126. Such an arrangement of aligner features may be referred to herein as stacked aligner features.

Stacked aligner features may include one or more orthodontic devices located at the same location on the tooth receiving cavity to crown. For example, as shown FIG. 1, the attachment 120, attachment receiving well 122, and the bite ramp 130 are located at the same location on the patient's tooth 140 when the aligner 110 is placed on the patient's dentition. In some embodiments, stacked aligner features may be determined by projecting a straight line normal to the patient's tooth at a location outward from the patient's tooth. The line may pass uninterrupted through each of the stacked aligner features. In some embodiments, the projected line may not be in a direction normal to the surface of the patient's teeth but may still pass uninterrupted through the stack aligner features. Uninterrupted may mean that the line passes through the stack aligner features without passing through a location external to the appliance. In some embodiments, stacked aligner features may be determined based on being at the same occlusal-gingival and mesial-distal location on the tooth. In some embodiments, such as for stacked features on occlusal surfaces, the stack aligner features may be determined based on the same buccal-lingual location and mesial-distal location on the tooth.

Stacking a bite ramp along with an attachment receiving well may allow for disocclusion of the patient's posterior teeth during a same stage of treatment in which extruded or moved in an occlusal direction or otherwise moved with forces imparted by attachment. Such an arrangement of features on a single and such treatment options during a same stage of treatment is not otherwise possible with conventional single-sheet thermoformed aligners. Accordingly by using the features and methods disclosed herein, a treatment plan and corresponding dental appliances may be generated to treat multiple aspects of a patient's malocclusion in a single stage of treatment.

While mandibular advancement with lingual and buccal features that extend from the lingual and buccal sides of an aligner are described herein. In some embodiments features may extend from occlusal surfaces of an aligner. For example, occlusal blocks may extend from occlusally from an occlusal surface, similar to a wing extending from a buccal or lingual surface. An occlusal block of a first aligner for a first arch of a patient may be shaped to engage with an occlusal block on a second aligner for second arch of the patient. Interaction of the occlusal blocks when the appliances are worn by the patient may adjust the positions of the patient's upper and lower jaws relative to each other, provide disocclusion of the jaws, or other benefits.

FIG. 2 depicts an aligner 210 having stacked features, namely a buccal wing 230 and a protrusion 250, is depicted as a dimple, on a buccal side of a tooth receiving cavity 150. The example embodiment also includes a repositioning jaw element 230 that extends from a buccal or lingual surface of the aligner 210. In the depicted embodiment, a buccal wing extends buccally and occlusally from a buccal side of the tooth receiving cavity 150. The buccal wing 230 may be configured to interact with a buccal wing of a second aligner on an opposing arch of the patient. The wings 230 may include respective engagement surfaces shaped to come into contact with each other during use to adjust the position of a patient's mandible. For example, the first repositioning jaw element and the second repositioning jaw element can be positioned to interface as the patient moves to a fully engaged sagittal jaw position of the patient's upper dentition and the patient's lower dentition in a manner to reposition the patient's jaw. As shown in FIG. 2, the repositioning jaw element 230 has a first outer surface 232 oriented to face the tongue of the patient surface and a second outer surface 234 oriented to face the cheek of the patient. During use, a mesial facing surface of a wing on a first arch of the patient may be configured to contact a distal facing surface of a wing on a second arch of the patient to apply jaw repositing forces to move the lower jaw relative to the upper jaw.

The appliance 210 includes a plurality of cavities 150 for receiving teeth 140 of the jaw. As discussed herein, two such appliances, an upper appliance and a lower appliance may be worn to adjust the mesial-distal relationship of the lower jaw with respect to the upper jaw. The upper appliance includes an upper advancement structure 230 (e.g., a maxillary or upper mandibular advancement feature) and the lower appliance includes a lower advancement structure 230 (e.g., a mandibular or lower mandibular advancement feature). The upper advancement structure 230 engages the lower advancement structure 230 to displace the lower arch anteriorly relative to the upper arch, thereby advancing the mandible when the upper and lower appliances are worn by the patient. Since the upper advancement structure is positioned on the upper arch at a location posteriorly relative to the position of the lower advancement structure on the lower arch, engagement of the upper and lower advancement structures produces an anterior force that pushes the mandible in an anterior direction. In some embodiments, the upper and lower advancement structures can be arranged to prevent posterior movement of the mandible while being unrestrictive of anterior, opening, or closing movements of the mandible.

In the embodiment of FIG. 2, the advancement structure 230 is depicted as being located on the buccal surfaces of the appliance 210. In some embodiments, the advancement structures 230 can be positioned on other surfaces of aligners 210, such as on the lingual surfaces or occlusal surfaces. Additionally, although FIG. 2 depicts a single advancement structures 203, the appliance 210 can be modified as desired to include multiple pairs of advancement structures located at different portions of the appliance 210 (e.g., a first pair located on the left side of the arch of the appliance 210 and a second pair located on the right side of the arch of the appliance 210).

In some embodiments, a protrusion may be added to an aligner. Various designs, orientations, and/or configurations of shaped features, such as the protrusion 250 depicted in FIG. 2 may be used to achieve force profiles favorable to some types of tooth movement. Shaped features can include various alterations or protrusions in a surface of an appliance, such as an internal surface shape of a tooth receiving cavity, including ridges, dimples, and the like. Dimples include protrusions having substantially the same dimensions along a width compared to the protrusion length and may be, for example, circular, square, or have the shape of other polygons. Ridges include protrusions having unequal length and width.

In some instances, ridge-shaped protrusions may provide differences and/or advantages for force application compared to other protrusion shapes, such as dimples. For example, dimples having substantially equal length and width to provide more of a point application of a force to a surface of a tooth. By comparison, a ridge-shaped protrusion may allow application force application more evenly distributed along a surface of a tooth, and may provide more precisely controlled tooth movement in some instances.

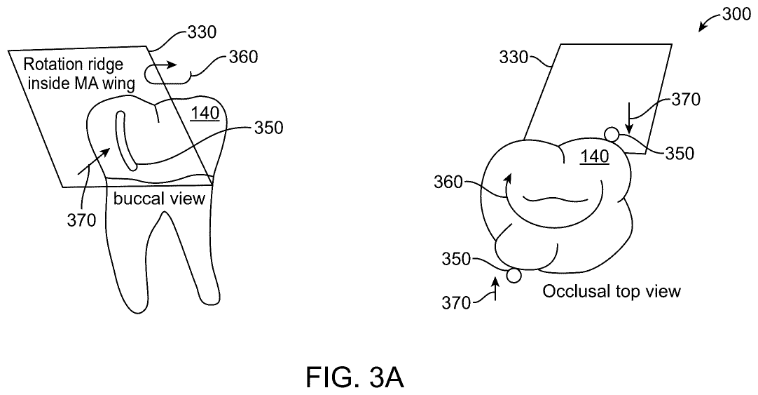

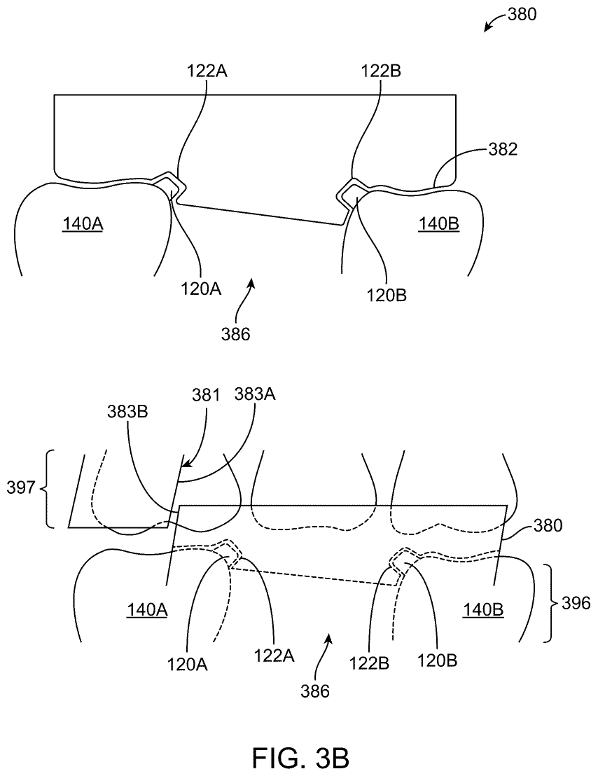

The shape, location, and orientation of shaped features may be determined based on the desired application of force and tooth movement as provided in a treatment plan. Exemplary designs/configurations of ridged protrusions are illustrated with reference to FIGS. 2 and 3. Dimples and ridges may be located on an interior surface of an aligner in many locations. Ridges may be continuous such that they are configured to contact a tooth surface along an uninterrupted length. Ridges may be oriented horizontally, in a mesial-distal direction, vertically, in an occlusal-gingival direction, or in other orientations.

In some embodiments, a series of dimples may be oriented along a length such that a plurality of protrusions that contact a tooth surface are separated by non-tooth contacting regions having a different height, which may be referred to as a non-continuous ridge. Both continuous and non-continuous type ridges function to apply a force vector along a length of the tooth, rather than at a single point as with a single dimple or bump-like protrusion. Shaped features, such as ridges can be designed in various shapes (e.g., curve, “L” shaped, “T” shaped, hook, etc.), as well as orientations (e.g., vertical, horizontal, slanted, etc.) and are not limited to any particular shape or orientation.

Any number of one or more shaped features can be included in design and fabrication of an appliance. In some embodiments, a cavity of an appliance can include a plurality of shaped features, such as protrusions. For example, a cavity can include at least two shaped features such as protrusions that are shaped and positioned within the cavity such that each of the protrusions are brought into contact with the received patient's tooth when the appliance is worn by the patient. Thus, a plurality of protrusions can configured and incorporated into appliance such that each of those protrusions engages the received tooth when the appliance is worn by the patient.

Various tooth movements can be accomplished using protrusions. Examples of specific movements that can be elicited by protrusions include translation, such as buccal-lingual translation, mesio-distal translation, extrusion, intrusion, root movements, first order rotation, second order root movement, and third order root movement. Protrusions and attachments may also be used to impart moments on teeth. Protrusions and attachments may be used to achieve any type of tooth movement, in any direction, in any plane.

Protrusions may be used in conjunction with the attachment features described herein.

As shown in FIG. 2, the protrusion 250 and the wing 230 of the appliance are stacked in the same location on the tooth receiving cavity of the appliance 210. With a conventional thermoformed appliance the wing 230 can be formed having an interior cavity having the same shape as the as the external shape of the wing. Such a shape would prevent the use of a protrusion in the same location as the wing 230. However, through the use of other fabrication techniques such as direct fabrication, the body of the wing may be solid or include support structures, such as infill to allow the tooth receiving cavity to accommodate a protrusion at the base of the wing. Such an arrangement of aligner features may be referred to herein as stacked aligner features.

Stacked aligner features may include one or more orthodontic devices located at the same location on the tooth receiving cavity to crown. For example, as shown FIG. 2, the protrusion 250 and the wing 230 are located at the same location on the patient's tooth 140 when the aligner 210 is placed on the patient's dentition. In some embodiments, stacked aligner features may be determined by projecting a line normal to the patient's tooth at a location outward from the patient's tooth. The line may pass uninterrupted through each of the stacked aligner features. In some embodiments, the projected line may not be in a direction normal to the surface of the patient's teeth but may still pass uninterrupted through the stack aligner features. Uninterrupted may mean that the line passes through the stack aligner features without passing through a location external to the appliance. In some embodiments, stacked aligner features may be determined based on being at the same occlusal-gingival and mesial-distal location on the tooth. In some embodiments, such as for stacked features on occlusal surfaces, the stack aligner features may be determined based on the same buccal-lingual location and mesial-distal location on the tooth.

In some embodiments, a treatment plan may include mandibular advancement and arch expansion. FIG. 2 depicts an example of such an embodiment. During arch expansion a patient's teeth, such as tooth 140 may have a force 270 applied to the crown. The force 270 may be applied in a buccal direction to expand or widen the arch. Such force 270 may be applied to the lingual surface of the patient's tooth via the aligner 210. The expansion force, being applied to the crown and offset from a center of rotation of the patient's tooth, may cause tipping. For example, as depicted in FIG. 3A, the tipping may be in a clockwise direction wherein the crown is tipped buccally in addition to translation caused by the force 270. Tipping may be undesirable. However, a counter moment 260 may be applied to the tooth 140 by a protrusion 250. The protrusion 250 may be applied at a location that is more occlusal (closer to the occlusal surface of the tooth) than the center of the force 270. The force applied by the protrusion 250 may be less than the force 270 such that the net force of force 270 and the force applied by the prostitution 250 results in a net buccal direction force to expand the arch. However, the moments may cancel each other out, because although the force applied by the protrusion is less, it is at a greater distance from a center of rotation of the tooth and therefore has a longer moment arm.

FIG. 3A depicts views of an aligner having two stacked features, namely a buccal wing and protrusions, which may be ridges 350, on buccal and lingual sides of a tooth receiving cavity. The example embodiment includes a repositioning jaw element 330 that extends from a buccal surface of the aligner 310. In the depicted embodiment, a buccal wing that extends buccally and occlusally from a buccal side of the tooth receiving cavity 150. The buccal wing 330 may be configured to interact with a buccal wing of a second aligner on an opposing arch of the patient. The wings 330 may include respective engagement surfaces shaped to come into contact with each other during use to adjust the position of a patient's mandible. For example, the first repositioning jaw element and the second repositioning jaw element can be positioned to interface as the patient moves to a fully engaged sagittal jaw position of the patient's upper dentition and the patient's lower dentition in a manner to reposition the patient's jaw.

The appliance 310 includes a plurality of cavities 150 for receiving teeth 140 of the jaw. As discussed herein, two such appliances, an upper appliance and a lower appliance may be worn to adjust the mesial-distal relationship of the lower jaw with respect to the upper jaw. The upper appliance includes an upper advancement structure 330 (e.g., a maxillary or upper mandibular advancement feature) and the lower appliance includes a lower advancement structure 330 (e.g., a mandibular or lower mandibular advancement feature). The upper advancement structure 330 engages the lower advancement structure 330 to displace the lower arch anteriorly relative to the upper arch, thereby advancing the mandible when the upper and lower appliances are worn by the patient. Since the upper advancement structure is positioned on the upper arch at a location posteriorly relative to the position of the lower advancement structure on the lower arch, engagement of the upper and lower advancement structures produces an anterior force that pushes the mandible in an anterior direction. In some embodiments, the upper and lower advancement structures can be arranged to prevent posterior movement of the mandible while being unrestrictive of anterior, opening, or closing movements of the mandible.

In some embodiments, a plurality of protrusions 350 may be added to an aligner. Various designs, orientations, and/or configurations of shaped features, such as the protrusion 350 depicted in FIG. 3A may be used to achieve force profiles favorable to some types of tooth movement. Shaped features can include various alterations or protrusions in a surface of an appliance, such as an internal surface shape of a tooth receiving cavity, including ridges, dimples, and the like.

As shown in FIG. 3A, one of the protrusions 350 and the wing 330 of the appliance are stacked in the same location on the tooth receiving cavity of the appliance 310. With a conventional thermoformed appliance the wing 330 formed having an interior cavity having the same shape as the external shape of the wing. Such a shape would prevent the use of a protrusion in the same location as the wing 330. However, through the use of other fabrication techniques such as direct fabrication, the body of the wing may be solid or include support structures, such as infill to allow the tooth receiving cavity to accommodate a protrusion at the base of the wing. Such an arrangement of aligner features referred to herein as stacked aligner features.

Stacked aligner features may include one or more of orthodontic devices located at the same location on the tooth receiving cavity to crown. For example, as shown FIG. 3A, the buccal protrusion 350 and the wing 330 are located at the same location on the patient's tooth 140 when the aligner 210 is placed on the patient's dentition. In some embodiments, stacked aligner features may be determined by projecting a line normal to the patient's tooth at a location outward from the patient's tooth. The line may pass uninterrupted through each of the stacked aligner features. In some embodiments the projected line may not be in a direction normal to the surface of the patient's teeth but may still pass uninterrupted through the stacked aligner features. Uninterrupted may mean that the line passes through the stack aligner features without passing through a location external to the appliance. In some embodiments, stacked aligner features may be determined based on being at the same occlusal-gingival and mesial-distal location on the tooth. In some embodiments, such as for stacked features on occlusal surfaces, the stack aligner features may be determined based on the same buccal-lingual location and mesial-distal location on the tooth.

In some embodiments, a treatment plan may include mandibular advancement and tooth rotation. FIG. 3A depicts such an embodiment. The tooth rotation is depicted in a clockwise direction in FIG. 3A about an axis that extends between the root and the crown, such as a long tooth axis. The buccal and lingual ridges 350 extend in a vertical or occlusal-gingival direction (sometimes referred to as a crown-root direction) along the tooth crown. The lingual ridge applies a force 370 on the distal end of the tooth with the buccal ridge 350 applies a force 370 on a mesial end of the tooth. The two forces may act about an axis of rotation of the tooth to cause generate a moment to rotate the tooth about the axis. With a conventional thermoformed appliance the wing 330 be formed having an interior cavity having the same shape as the as the external shape of the wing. Such a shape would prevent the use of a protrusion in the same location as the wing 330. However, through the use of other fabrication techniques such as direct fabrication, the body of the wing may be solid or include support structures, such as infill to allow the tooth receiving cavity to accommodate a protrusion at the base of the wing.

FIG. 3B depicts a cross sectional view two stacked features, a wing 380, which may be a buccal or lingual wing of an aligner and attachments 122A, 122B. The tooth receiving cavities and the body of the aligner are omitted for clarity. The example embodiment includes a repositioning jaw element, such as wing 380, that extends from a lingual or buccal surface of an aligner on a first arch 396 and may include a portion that extends from the occlusal surface. In the depicted embodiment, a buccal wing extends buccally and occlusally from a buccal side of a tooth receiving cavity. The wing 380 may be configured to interact with a wing 381 of a second aligner on an opposing arch 379 of the patient. The wings 380, 381 may include respective engagement surfaces 383A, 383B shaped to come into contact with each other during use to adjust the position of a patient's mandible. For example, the wing 380 and the second wing 381 can be positioned to interface as the patient moves to a fully engaged sagittal jaw position of the patient's upper dentition and the patient's lower dentition in a manner to reposition the patient's jaw.

The appliance may include a plurality of cavities for receiving teeth 140 of the jaw. As discussed herein, two such appliances, an upper appliance and a lower appliance may be worn to adjust the mesial-distal relationship of the lower jaw with respect to the upper jaw. The upper appliance includes an upper wing 381 (e.g., a maxillary or upper mandibular advancement feature) and the lower appliance includes a lower wing 380 (e.g., a mandibular or lower mandibular advancement feature). The upper wing 381 engages the lower wing 380 to displace the lower arch anteriorly relative to the upper arch, thereby advancing the mandible when the upper and lower appliances are worn by the patient. Since the upper wing is positioned on the upper arch at a location posteriorly relative to the position of the lower wing on the lower arch, engagement of the upper and lower wings produces an anterior force that pushes the mandible in an anterior direction. In some embodiments, the upper and lower wings can be arranged to prevent posterior movement of the mandible while being unrestrictive of anterior, opening, or closing movements of the mandible.

In some embodiments, attachments 120A, 120B may be attached to mesial and/or distal sides of the teeth 140, such as on a mesial or distal cusp of the tooth 140. Various designs, orientations, and/or configurations of the attachments 120A, 120B depicted in FIG. 3B may be used to achieve force profiles favorable to some types of tooth movement.

As shown in FIG. 3B, one of the attachments 120A, 120B and the wing 380 of the appliance are stacked in the same location on a tooth receiving cavity of the appliance. With a conventional thermoformed appliance the wing 380 formed having an interior cavity having the same shape as the external shape of the wing. Such a shape would prevent the use of an attachment protrusion in the same location as the wing 380. However, through the use of other fabrication techniques such as direct fabrication, the body of the wing may be solid or include support structures, such as infill to allow the tooth receiving cavity to accommodate an attachment receiving cavity 122A, 122B at the base of the wing. Such an arrangement of aligner features referred to herein as stacked aligner features.

In some embodiments, a treatment plan may include mandibular advancement and while maintaining a gap 386 between adjacent or non-adjacent teeth, such as for a missing or erupting tooth. The attachments 122A, 122B may also provide for tipping control, rotation, greater engagement with the aligner, and other benefits. FIG. 3B depicts such an embodiment

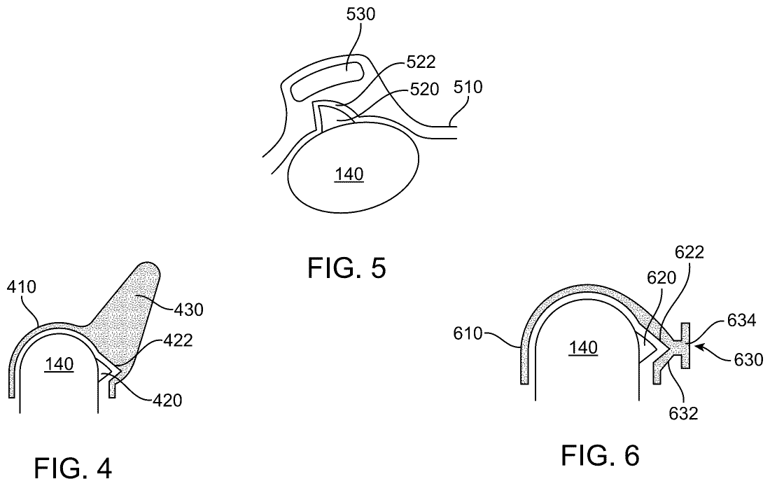

FIG. 4 depicts an aligner having stacked features, namely a buccal wing 430 and an attachment receiving cavity 422, on a buccal side of a tooth receiving cavity 410 with a tooth 140 received therein. The buccal wing may be as described with respect to the buccal wing 230, 330 of FIGS. 2 and 3. For example, the buccal wing 430 may be configured to interact with a buccal wing of a second aligner on an opposing arch of the patient. The wings 430 may include respective engagement surfaces shaped to come into contact with each other during use to adjust the position of a patient's mandible. For example, the first repositioning jaw element and the second repositioning jaw element can be positioned to interface as the patient moves to a fully engaged sagittal jaw position of the patient's upper dentition and the patient's lower dentition in a manner to reposition the patient's jaw.

The aligner 410 may also include an attachment receiving well 422 shaped to receive an attachment 420. The attachment 420 and attachment receiving well 422 may be as described with respect to attachment 120 and attachment receiving well 122 of FIG. 1. For example, one or more attachment devices may be attached to preselected attachment locations on the teeth or dental features to provide a desired force that may not be achievable without an attachment. Specific design and location of these attachment devices may be determined based on the movements of the treatment plan and may provide greater repositioning forces, anchoring ability, and appliance retention as compared to a tooth without an attachment, such as the ability to extrude, rotate, and otherwise manipulate teeth. For example, the attachment 420 may engage with the attachment receiving well 422 to provide additional or greater retention of the aligner on the tooth as compared to a system without an attachment.

The attachment 420 is shown bonded to a crown of a tooth 140 above the gingiva. The attachment 420 may include an attachment body having a base. The base may be a surface of the attachment body for direct bonding to the tooth 140. The outer surface of the attachment body may be shaped to engage with or received within an attachment receiving well of the aligner. The exterior surface contours or shape of the body of the attachment may match the interior contours or shape of the attachment receiving well. In some embodiments, the attachment 420 and the attachment receiving well 422 may have different shapes such that only a portion of the exterior surface of the body of the attachment 420 comes into contact with only a portion of the interior surface of the attachment receiving well 422.

As shown in FIG. 4, the wing 430 and the attachment receiving well 422 of the appliance 410 are stacked in the same location on the tooth receiving cavity of the appliance. With a conventional thermoformed appliance the wing 430 may be formed having an interior cavity having the same shape as the as the external shape of the bite ramp. Such a shape would prevent the use of an attachment 420 in the same location as the wing 430. However, through the use of other fabrication techniques such as direct fabrication, the body of the wing 430 may be solid or include support structures or infill which allows the wing 430 to accommodate an attachment receiving well 422.

Stacking a wing along with an attachment receiving well in attachment may allow for mandibular advancement of the patient's lower jaw teeth during a same stage of treatment in which extruded or moved in an occlusal direction or otherwise moved with forces imparted by attachment. Such an arrangement features on a single and such treatment options during a same stage of treatment with conventional single-sheet thermoformed aligners. The attachment may also provide for greater retention of the aligner on the tooth during mandibular advancement using the wing 430. Accordingly using the features and methods disclosed herein treatment may be generated to treat multiple aspects of a patient's malocclusion in a single stage of treatment.

FIG. 5 depicts an aligner 510 having stacked features, namely compliance indicator 530 and an attachment receiving cavity 522, on a sidewall of a tooth receiving cavity. A compliance indicator measures or provides a way to observe a patent's compliance with wearing an aligner. The compliance indicator may provide human readable or observable compliance indication by changing physical or mechanical or visual properties that are readily observable by a human. In some embodiments, the compliance indication is machine readable. For instance, the electrical characteristics of an appliance may be altered during wearing of the appliance. An electrical measurement can be made by a computer for detecting compliance. In another embodiment that uses biomarkers, a computer with a biomarker sensor can be used with a suitable computer program to detect compliance. In yet another embodiment, a color change can be detected by a computer vision program to detect compliance. The compliance indication may change based on an amount of use of the appliance by a patient.

For example, the compliance indicator 530 may include a biodegradable polymer material. During use, the polymer material changes shape or size or color. For example, the volume of the biodegradable polymer material may be reduced during use. In some embodiments, the compliance indicator may be a button, such as a biodegradable polymer button. The button can be molded from a biodegradable polymer with the aligner. The button may have a predetermined degradation period such as a two week degradation period in the constant presence of oral fluids. Compliance may be measured based on the size or remaining volume of the compliance indicator after a period of time, which may be predetermined.

The compliance indicator may be an electronic compliance indicator that measures the time the appliance is applied to the tooth based on a sensor, such as a position sensor or switch that is activated when the appliance is worn by a patient. A humidity sensor may be used, and a timer activated when the humidity sensor measures a humidity consistent with the aligner being worn by a patient. Other compliance sensors may also be used.

The aligner 510 may also include an attachment receiving well 522 shaped to receive an attachment 520. The attachment 520 and attachment receiving well 522 may be as described with respect to attachment 120 and attachment receiving well 122 of FIG. 1. For example, one or more attachment devices may be attached to preselected attachment locations on the teeth or dental features to provide a desired force that may not be achievable without an attachment. Specific design and location of these attachment devices may be determined based on the movements of the treatment plan and may provide greater repositioning forces, anchoring ability, and appliance retention as compared to a tooth without an attachment, such as the ability to extrude, rotate, and otherwise manipulate teeth. For example, the attachment 520 may engage with the attachment receiving well 522 to provide additional or greater retention of the aligner on the tooth as compared to a system without an attachment. In some embodiments, a compliance indicator may be embedded within another appliance feature, such as a wing or occlusal block.

FIG. 6 depicts an aligner 610 having two stacked features, namely a button 630 and an attachment receiving cavity 622, on a sidewall of a tooth receiving cavity. The aligner 610 may also include an attachment receiving well 622 shaped to receive an attachment 520. The attachment 620 and attachment receiving well 622 may be as described with respect to attachment 120 and attachment receiving well 122 of FIG. 1. For example, one or more attachment devices may be attached to preselected attachment locations on the teeth or dental features to provide a desired force that may not be achievable without an attachment. Specific design and location of these attachment devices may be determined based on the tooth and jaw movements in the treatment plan and may provide greater repositioning forces, anchoring ability, and appliance retention as compared to a tooth without an attachment, such as the ability to extrude, rotate, and otherwise manipulate teeth. For example, the attachment 620 may engage with the attachment receiving well 622 to provide additional or greater retention of the aligner on the tooth as compared to a system without an attachment.

The button 630 is an aligner feature that may function to facilitate the application of orthodontic treatment forces to the teeth that aligners alone cannot achieve effectively. A button may include shaft 632 and a head 634. The shaft extends between the aligner shell, such as an exterior surface of sidewall of a tooth receiving cavity, to a the head 634. The head may have a diameter greater than a diameter of the shaft.

Buttons can serve as anchor points for elastic bands. Elastics may be used to correct bite discrepancies by pulling the lower jaw in relation to the upper jaw, such as forward or backward or left or right relative to the upper jaw. Such as in cases where significant bite adjustments are needed, such as correcting overbites, underbites, or crossbites.

In some embodiments, buttons provide additional grip or leverage points for the aligners. Such as for rotating teeth or moving them vertically, which are movements that might be challenging with aligners alone. An attachment receiving cavity stacked with a button may provide for transfer of the force of the elastic to the tooth with also increasing retention of the aligner.

Similar to a button, in some embodiments, an aligner may include other elastic engagement devices, such as a hook. For example, an appliance can include a hook configured to interface with an orthodontic elastic member so as to react a force from the elastic member into the patient-worn appliance, thereby applying (e.g., supplementing) forces other than or in addition to the forces applied to the patient's teeth and generated solely by the positioning appliance(s) in the absence of the coupled elastic member. The appliance and/or hook thereof can be configured to more optimally engage an elastic member when the appliance is worn by the patient. In some embodiments, for example, the hook can be configured to be laterally offset from another portion of the appliance, such as a portion of the appliance that engages the patient's teeth when worn. For example, a hook can be offset (e.g., laterally offset) from a portion of the appliance that engages a buccal surface of a tooth when the appliance is coupled with the patient's teeth. In such an embodiment, the hook may be offset even when no orthodontic elastic member is coupled with the tooth. Similar to buttons, hooks may also be stacked with other aligner features.

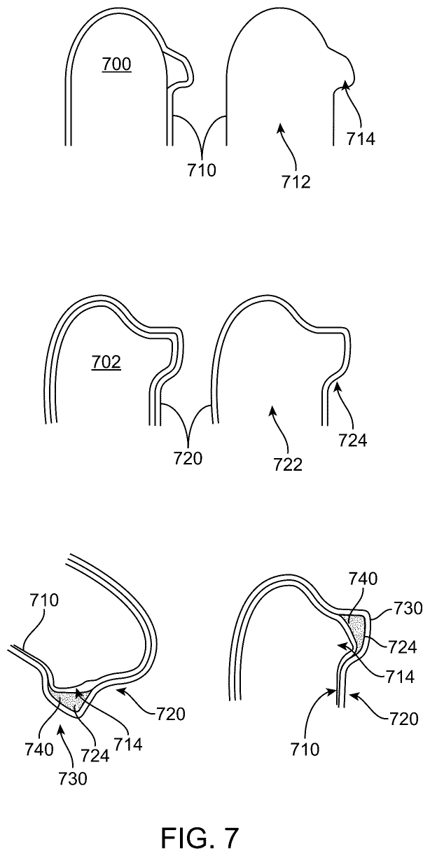

FIG. 7 depicts a process of fabricating a multi-layer thermoformed aligner having two stacked features, namely a buccal wing and an attachment receiving cavity.

While direct fabrication, such as through 3D printing, is well suited for the fabrication of aligners with stacked features, in some embodiments, a double thermoformed process may be used to generate some stacked features. For example, an attachment receiving well may be stacked with a wing or other feature, as shown in FIG. 7. At a first step of the process, a mold 700 may be fabricated. The mold may be for forming an inner aligner structure 710 having a protrusion 714 that extends outward from the surface of the inner aligner to for the tooth receiving cavity 712 and an attachment receiving well 714 of an aligner. A sheet of thermoplastic material may be thermoformed over the mold 700 to fabricate the inner aligner structure 710. The mold 700 may have a surface shaped to form the inner, inward, or tooth facing surface of a dental appliance, such as an orthodontic aligner.

A second mold 702 may be formed for use in fabricating a second aligner portion, such as an outer aligner structure 720 out of a second sheet of thermoplastic material. The second aligner mold may have a feature for fabricating a protrusion 724. The protrusion may, for example, be a buccal wing. The mold may also form an aligner receiving well 722 shaped to receive the inner aligner therein. The mold 702 may have a surface shaped to form the external, outward, or non-tooth facing surface of a dental appliance, such as an orthodontic aligner.

As may be observed in the figure, the outer surface of the inner aligner at the attachment receiving well 714 is not shaped to match the inner surface of the outer aligner at the projection 724. When the inner aligner is placed within the outer aligner, as shown in the bottom left of FIG. 7, a cavity 740 may be formed between the inner aligner portion 710 and the outer aligner portion 720. A curable or settable material, such as a UV curable resin may fill the cavity 740 and then cured. After curing the inner and outer aligner portions may be bonded together, such as though laser welding or other methods.

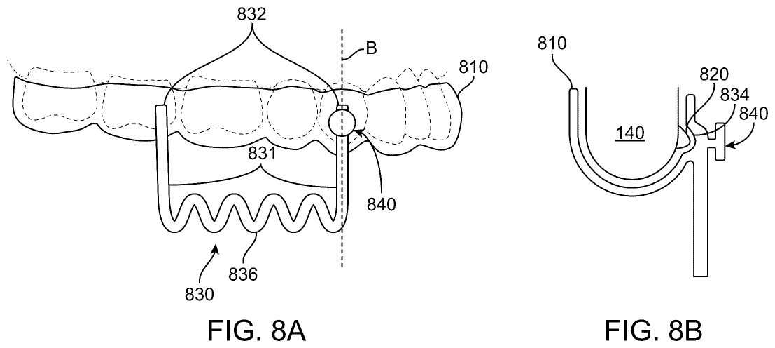

FIGS. 8A and 8B depict views of an aligner having three stacked features, namely a power arm 830, an attachment receiving cavity 834, and a button 840, on a sidewall of a tooth receiving cavity. The button, attachment, and attachment receiving well may be as described elsewhere herein. The power arm feature 830 may include two arms 831 that are coupled to an appliance shell 810 at connection points 832. The appliance shell 310 comprises a plurality of tooth-receiving cavities, each of which may fit a patient's tooth 140 in order to apply tooth-moving forces. In some embodiments, the connection points 831 may comprise a direct material connection formed during direct fabrication of the appliance.

The power arms are connected via a connecting structure 836 (e.g., an elastic, spring, or the like) which applies an elastic force on power arms, which in turn allows power arms 831 to apply a tooth-moving force on a patient's teeth. The power arms 831 act as a lever, applying force and/or torque to connection points 832, and thereby to the appliance shell 810. The appliance shell, in turn, applies force on a patient's teeth through contact between the teeth and the tooth-receiving cavities of the shell. By choosing properties such as the length and connection points of power arm. Force may be applied to teeth at or near their center of resistance, without inducing unwanted tipping. In order to act as an effective lever, power arms 831 can be fabricated from a rigid material, which may differ from the material from which the shell 810 or the connecting structure 832 are fabricated, for example.

Depending on the chosen design of the connecting structure 836, an outward force or an inward force may be provided. The direction of the force may be determined by the rest length of the connecting structure 836 relative to the distance between connection points, wherein a longer rest length causes an outward force and a shorter rest length shorter causes an inward force. The magnitude may be determined by a modulus of elasticity or spring constant of the connecting structure 836 and the magnitude of difference between the rest length of the connecting structure 836 and the distance between connection points, as may be approximated, for example, by Hooke's Law. In some embodiments, the connecting structure 836 may be replaced with a separately-applied elastic material such as a band, and in some embodiments, a band may be combined with the connecting structure 836 to provide increased elastic force. In some embodiments, an appliance may comprise a plurality of power arm pairs, each pair connected with an elastic spring structure.

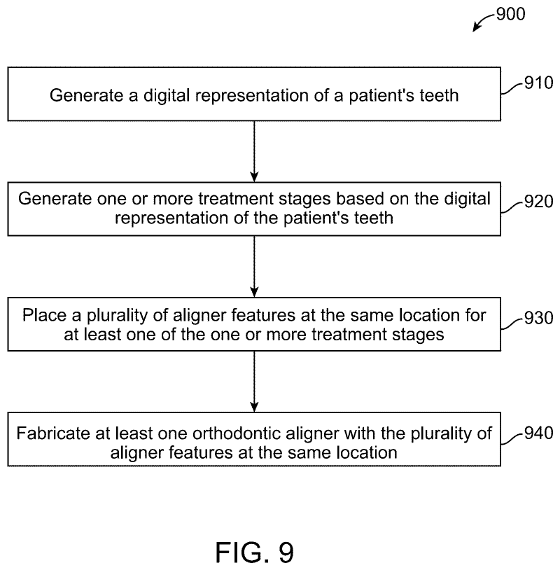

FIG. 9 depicts a process for designing and fabricating an aligner having stacked features. FIG. 9 illustrates a method 900 for digitally planning an orthodontic treatment and/or design or fabrication of an appliance, in accordance with many embodiments. The method 900 can be applied to any of the treatment procedures described herein and can be performed by any suitable data processing system. Any embodiment of the appliances described herein can be designed or fabricated using the method 900.

At block 910, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

At block 920, one or more treatment stages of a dental treatment plan are generated based on the digital representation of the teeth. The treatment stages can be incremental repositioning stages of an orthodontic treatment procedure designed to move one or more of the patient's teeth from an initial tooth arrangement towards a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria. In some embodiments, the treatment plan may include one or more stages wherein mandibular adjustment takes place.

At block 930, based on the desired movements and forces in the treatment plan, a plurality of aligner features may be placed at a same location for at least one of the one or more treatment stages. The features may be stacked on top of each other, as descried herein. Any of the aligner features discussed herein may be stacked with any of the other aligner features discussed herein.

At block 940, at least one orthodontic appliance with stacked aligner features is fabricated based on the generated treatment stages. For example, a set of appliances can be fabricated to be sequentially worn by the patient to incrementally reposition the teeth from the initial arrangement to the target arrangement. Some of the appliances can be shaped to accommodate a tooth arrangement specified by one of the treatment stages. Alternatively or in combination, some of the appliances can be shaped to accommodate a tooth arrangement that is different from the target arrangement for the corresponding treatment stage. For example, an appliance may have a geometry corresponding to an overcorrected tooth arrangement. Such an appliance may be used to ensure that a suitable amount of force is expressed on the teeth as they approach or attain their desired target positions for the treatment stage. As another example, an appliance can be designed in order to apply a specified force system on the teeth and may not have a geometry corresponding to any current or planned arrangement of the patient's teeth.

The various embodiments of the orthodontic appliances presented herein can be fabricated in a wide variety of ways. In some embodiments, the orthodontic appliances herein (or portions thereof) can be produced using direct fabrication, such as additive manufacturing techniques (also referred to herein as “3D printing) or subtractive manufacturing techniques (e.g., milling). In some embodiments, direct fabrication involves forming an object (e.g., an orthodontic appliance or a portion thereof) without using a physical template (e.g., mold, mask etc.) to define the object geometry. Additive manufacturing techniques can be categorized as follows: (1) vat photopolymerization (e.g., stereolithography), in which an object is constructed layer by layer from a vat of liquid photopolymer resin; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) fused deposition modeling (FDM), in which material is drawn though a nozzle, heated, and deposited layer by layer; (5) powder bed fusion, including but not limited to direct metal laser sintering (DMLS), electron beam melting (EBM), selective heat sintering (SHS), selective laser melting (SLM), and selective laser sintering (SLS); (6) sheet lamination, including but not limited to laminated object manufacturing (LOM) and ultrasonic additive manufacturing (UAM); and (7) directed energy deposition, including but not limited to laser engineering net shaping, directed light fabrication, direct metal deposition, and 3D laser cladding. For example, stereolithography can be used to directly fabricate one or more of the appliances herein. In some embodiments, stereolithography involves selective polymerization of a photosensitive resin (e.g., a photopolymer) according to a desired cross-sectional shape using light (e.g., ultraviolet light). The object geometry can be built up in a layer-by-layer fashion by sequentially polymerizing a plurality of object cross-sections. As another example, the appliances herein can be directly fabricated using selective laser sintering. In some embodiments, selective laser sintering involves using a laser beam to selectively melt and fuse a layer of powdered material according to a desired cross-sectional shape in order to build up the object geometry. As yet another example, the appliances herein can be directly fabricated by fused deposition modeling. In some embodiments, fused deposition modeling involves melting and selectively depositing a thin filament of thermoplastic polymer in a layer-by-layer manner in order to form an object. In yet another example, material jetting can be used to directly fabricate the appliances herein. In some embodiments, material jetting involves jetting or extruding one or more materials onto a build surface in order to form successive layers of the object geometry.

In some embodiments, the direct fabrication methods provided herein build up the object geometry in a layer-by-layer fashion, with successive layers being formed in discrete build steps. Alternatively or in combination, direct fabrication methods that allow for continuous build-up of an object geometry can be used, referred to herein as “continuous direct fabrication.” Various types of continuous direct fabrication methods can be used. As an example, in some embodiments, the appliances herein are fabricated using “continuous liquid interphase printing,” in which an object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Continuous liquid interphase printing can achieve fabrication speeds about 25 times to about 100 times faster than other direct fabrication methods, and speeds about 1000 times faster can be achieved with the incorporation of cooling systems.

As another example, a continuous direct fabrication method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved.

In another example, a continuous direct fabrication method can involve extruding a composite material composed of a curable liquid material surrounding a solid strand. The composite material can be extruded along a continuous three-dimensional path in order to form the object.

In yet another example, a continuous direct fabrication method utilizes a “heliolithography” approach in which the liquid photopolymer is cured with focused radiation while the build platform is continuously rotated and raised. Accordingly, the object geometry can be continuously built up along a spiral build path.

The direct fabrication approaches provided herein are compatible with a wide variety of materials, including but not limited to one or more of the following: polymer matrix reinforced with ceramic or metallic polymers, a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, a thermoplastic polyamide elastomer, or combinations thereof. The materials used for direct fabrication can be provided in an uncured form (e.g., as a liquid, resin, powder, etc.) and can be cured (e.g., by photopolymerization, light curing, gas curing, laser curing, crosslinking, etc.) in order to form an orthodontic appliance or a portion thereof. The properties of the material before curing may differ from the properties of the material after curing. Once cured, the materials herein can exhibit sufficient strength, stiffness, durability, biocompatibility, etc. for use in an orthodontic appliance. The post-curing properties of the materials used can be selected according to the desired properties for the corresponding portions of the appliance.

In some embodiments, relatively rigid portions of the orthodontic appliance can be formed via direct fabrication using one or more of the following materials: a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, and/or a polytrimethylene terephthalate.

In some embodiments, relatively elastic portions of the orthodontic appliance can be formed via direct fabrication using one or more of the following materials: a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, and/or a thermoplastic polyamide elastomer.

Optionally, the direct fabrication methods described herein allow for fabrication of an appliance including multiple materials, referred to herein as “multi-material direct fabrication.” In some embodiments, a multi-material direct fabrication method involves concurrently forming an object from multiple materials in a single manufacturing step using the same fabrication machine and method. For instance, a multi-tip extrusion apparatus can be used to selectively dispense multiple types of materials (e.g., resins, liquids, solids, or combinations thereof) from distinct material supply sources in order to fabricate an object from a plurality of different materials.

Alternatively or in combination, a multi-material direct fabrication method can involve forming an object from multiple materials in a plurality of sequential manufacturing steps. For instance, a first portion of the object can be formed from a first material in accordance with any of the direct fabrication methods herein, then a second portion of the object can be formed from a second material in accordance with methods herein, and so on, until the entirety of the object has been formed. The relative arrangement of the first and second portions can be varied as desired, e.g., the first portion can be partially or wholly encapsulated by the second portion of the object. The sequential manufacturing steps can be performed using the same fabrication machine or different fabrication machines, and can be performed using the same fabrication method or different fabrication methods. For example, a sequential multi-manufacturing procedure can involve forming a first portion of the object using stereolithography and a second portion of the object using fused deposition modeling.

Direct fabrication can provide various advantages compared to other manufacturing approaches. For instance, in contrast to indirect fabrication, direct fabrication permits production of an orthodontic appliance without utilizing any molds or templates for shaping the appliance, thus reducing the number of manufacturing steps involved and improving the resolution and accuracy of the final appliance geometry. Additionally, direct fabrication permits precise control over the three-dimensional geometry of the appliance, such as the appliance thickness. Complex structures and/or auxiliary components can be formed integrally as a single piece with the appliance shell in a single manufacturing step, rather than being added to the shell in a separate manufacturing step.

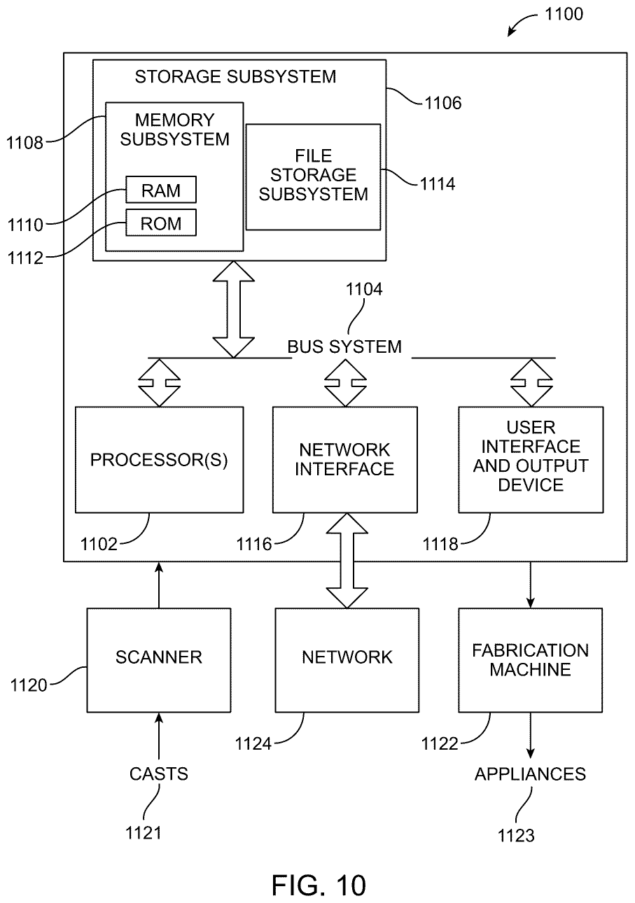

FIG. 10 depicts a simplified block diagram of an orthodontic aligner design and fabrication system, which may be a data processing system. The system 1100 may include at least one processor 1102 that communicates with one or more peripheral devices via bus subsystem 1104. These peripheral devices typically include a storage subsystem 1106 (memory subsystem 1108 and file storage subsystem 1114), a set of user interface input and output devices 1118, and an interface to outside networks 1116. This interface is shown schematically as “Network Interface” block 1116, and is coupled to corresponding interface devices in other data processing systems via communication network interface 1124. System 1100 can include, for example, one or more computers, such as a personal computer, workstation, mainframe, laptop, and the like.

The user interface input devices 1118 are not limited to any particular device, and can typically include, for example, a keyboard, pointing device, mouse, scanner, interactive displays, touchpad, joysticks, etc. Similarly, various user interface output devices can be employed in a system of the invention, and can include, for example, one or more of a printer, display (e.g., visual, non-visual) system/subsystem, controller, projection device, audio output, and the like.

Storage subsystem 1106 maintains the basic required programming, including computer readable media having instructions (e.g., operating instructions, etc.), and data constructs. The program modules discussed herein are typically stored in storage subsystem 1106. Storage subsystem 1106 typically includes memory subsystem 1108 and file storage subsystem 1114. Memory subsystem 1108 typically includes a number of memories (e.g., RAM 1110, ROM 1112, etc.) including computer readable memory for storage of fixed instructions, instructions and data during program execution, basic input/output system, etc. File storage subsystem 1114 provides persistent (non-volatile) storage for program and data files, and can include one or more removable or fixed drives or media, hard disk, floppy disk, CD-ROM, DVD, optical drives, and the like. One or more of the storage systems, drives, etc. may be located at a remote location, such coupled via a server on a network or via the internet/World Wide Web. In this context, the term “bus subsystem” is used generically so as to include any mechanism for letting the various components and subsystems communicate with each other as intended and can include a variety of suitable components/systems that would be known or recognized as suitable for use therein. It will be recognized that various components of the system can be, but need not necessarily be at the same physical location, but could be connected via various local-area or wide-area network media, transmission systems, etc.

Scanner 1120 includes any means for obtaining a digital representation (e.g., images, surface topography data, etc.) of a patient's teeth (e.g., by scanning physical models of the teeth such as casts 1121, by scanning impressions taken of the teeth, or by directly scanning the intraoral cavity), which can be obtained either from the patient or from treating professional, such as an orthodontist, and includes means of providing the digital representation to system 1100 for further processing. Scanner 1120 may be located at a location remote with respect to other components of the system and can communicate image data and/or information to system 1100, for example, via a network interface 1124. Fabrication system 1122 fabricates appliances 1123 based on a treatment plan, including data set information received from system 1100. Fabrication machine 1122 can, for example, be located at a remote location and receive data set information from system 1100 via network interface 1124.

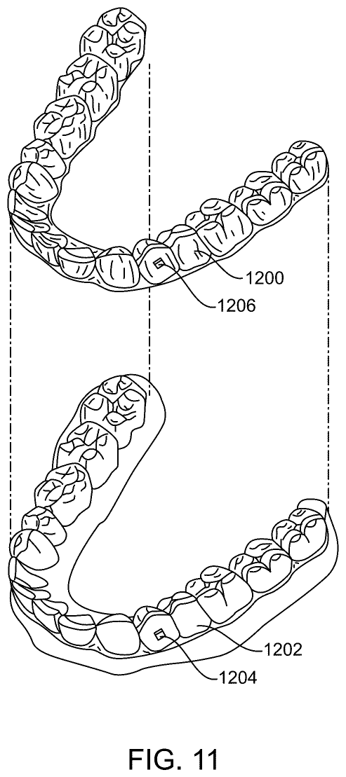

FIG. 11 illustrates an exemplary tooth repositioning appliance 1200, such as an aligner that can be worn by a patient in order to achieve an incremental repositioning of individual teeth 1202 in the jaw. The appliance can include a shell (e.g., a continuous polymeric shell or a segmented shell) having teeth-receiving cavities that receive and resiliently reposition the teeth. An appliance or portion(s) thereof may be indirectly fabricated using a physical model of teeth. For example, an appliance (e.g., polymeric appliance) can be formed using a physical model of teeth and a sheet of suitable layers of polymeric material. The physical model (e.g., physical mold) of teeth can be formed through a variety of techniques, including 3D printing. The appliance can be formed by thermoforming the appliance over the physical model. In some embodiments, a physical appliance is directly fabricated, e.g., using additive manufacturing techniques, from a digital model of an appliance. In some embodiments, the physical appliance may be created through a variety of direct formation techniques, such as 3D printing. An appliance can fit over all teeth present in an upper or lower jaw, or less than all of the teeth. The appliance can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance can be a generic appliance configured to receive the teeth, but not necessarily shaped to match the topography of the patient's teeth. In some cases, only certain teeth received by an appliance will be repositioned by the appliance while other teeth can provide a base or anchor region for holding the appliance in place as it applies force against the tooth or teeth targeted for repositioning. In some cases, some or most, and even all, of the teeth will be repositioned at some point during treatment. Teeth that are moved can also serve as a base or anchor for holding the appliance as it is worn by the patient. In some embodiments, no wires or other means will be provided for holding an appliance in place over the teeth. In some cases, however, it may be desirable or necessary to provide individual attachments or other anchoring elements 1204 on teeth 1202 with corresponding receptacles or apertures 1206 in the appliance 1200 so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the URL “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

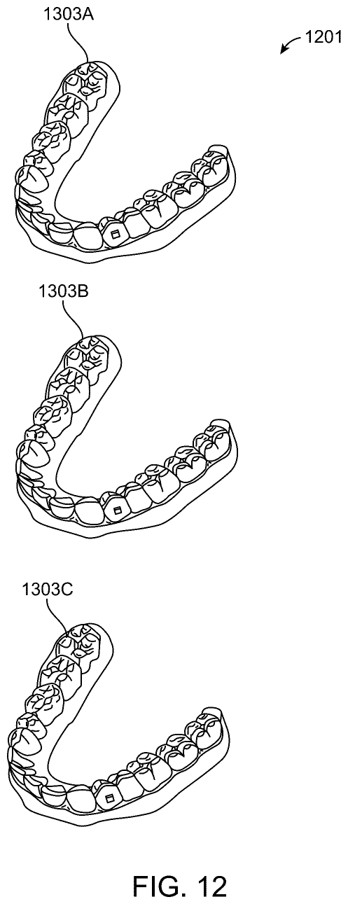

FIG. 12 illustrates a tooth repositioning system 1300 including a plurality of appliances 1303A, 1303B, 1303C. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1300 can include a first appliance 1303A corresponding to an initial tooth arrangement, one or more intermediate appliances 1303B corresponding to one or more intermediate arrangements, and a final appliance 1303C corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

Optionally, in cases involving more complex movements or treatment plans, it may be beneficial to utilize auxiliary components (e.g., features, accessories, structures, devices, components, and the like) in conjunction with an orthodontic appliance. Examples of such accessories include but are not limited to elastics, wires, springs, bars, arch expanders, palatal expanders, twin blocks, occlusal blocks, bite ramps, mandibular advancement splints, bite plates, pontics, hooks, brackets, headgear tubes, springs, bumper tubes, palatal bars, frameworks, pin-and-tube apparatuses, buccal shields, buccinator bows, wire shields, lingual flanges and pads, lip pads or bumpers, protrusions, divots, and the like. In some embodiments, the appliances, systems and methods described herein include improved orthodontic appliances with integrally formed features that are shaped to couple to such auxiliary components, or that replace such auxiliary components.

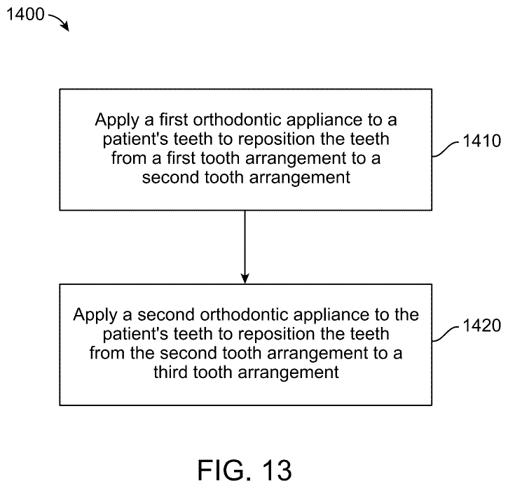

FIG. 13 illustrates a method 1400 of orthodontic treatment using a plurality of appliances, in accordance with many embodiments. The method 1400 can be practiced using any of the appliances or appliance sets described herein. In step 1410, a first orthodontic appliance is applied to a patient's teeth in order to reposition the teeth from a first tooth arrangement to a second tooth arrangement. In step 1420, a second orthodontic appliance is applied to the patient's teeth in order to reposition the teeth from the second tooth arrangement to a third tooth arrangement. The method 1400 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

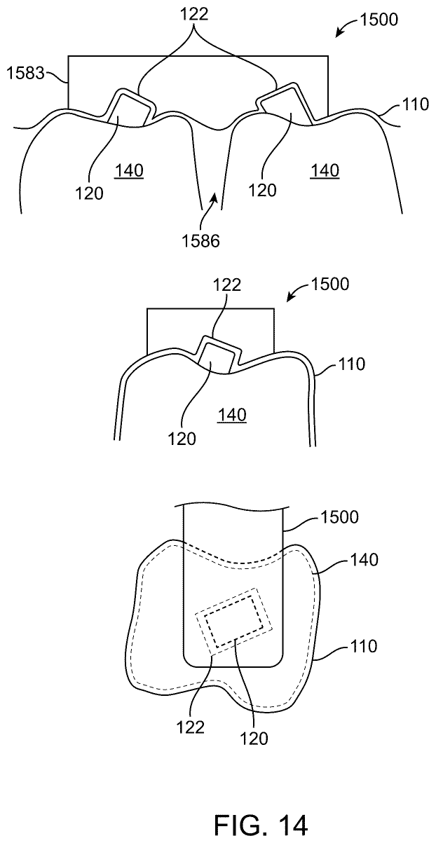

FIG. 14 depicts, from top to bottom, a mesial-distal cross-section, a buccal-lingual cross-section, and an occlusal view of an occlusal block 1500 stacked with attachments 122. The example embodiment includes a jaw repositioning element, such as occlusal block 1500, that extends from an occlusal surface of an aligner on a first arch and may. The occlusal block 1500 may be configured to interact with an occlusal block of a second aligner on an opposing arch of the patient. The occlusal blocks may include respective engagement surfaces 1583 shaped to come into contact with each other during use to adjust the position of a patient's mandible. For example, an upper occlusal block and a lower occlusal block on respective upper and lower aligners 110 can be positioned to interface as the patient moves to a fully engaged sagittal jaw position of the patient's upper dentition and the patient's lower dentition in a manner to reposition the patient's jaw.

The appliance may include a plurality of cavities for receiving teeth 140 of the jaw. As discussed herein, two such appliances, an upper appliance and a lower appliance may be worn to adjust the mesial-distal relationship of the lower jaw with respect to the upper jaw. The upper appliance includes a first occlusal block (e.g., a maxillary or upper mandibular advancement feature) and the lower appliance includes a second occlusal block (e.g., a mandibular or lower mandibular advancement feature). The upper occlusal block engages the lower occlusal block to displace the lower arch anteriorly relative to the upper arch, thereby advancing the mandible when the upper and lower appliances are worn by the patient. Since the upper occlusal block is positioned on the upper arch at a location posteriorly relative to the position of the lower occlusal block on the lower arch, engagement of the upper and lower occlusal blocks produces an anterior force that pushes the mandible in an anterior direction. In some embodiments, the upper and lower wings can be arranged to prevent posterior movement of the mandible while being unrestrictive of anterior, opening, or closing movements of the mandible.

In some embodiments, attachments 120 may be attached to occlusal surfaces of the teeth 140, such as on an occlusal portion of a mesial or distal cusp of the tooth 140. Various designs, orientations, and/or configurations of the attachments 120 may be used to achieve force profiles favorable to some types of tooth movement.

As shown in FIG. 14, one of the attachments 120 and the occlusal block 1500 of the appliance are stacked in the same location on a tooth receiving cavity of the appliance. With a conventional thermoformed appliance the occlusal block 1500 is formed having an interior cavity having the same shape as the external shape of the wing. Such a shape would prevent the use of an attachment protrusion in the same location as the occlusal block. However, through the use of other fabrication techniques such as direct fabrication, the body of the wing may be solid or include support structures, such as infill to allow the tooth receiving cavity to accommodate an attachment receiving cavity 122 at the base of the occlusal block.

In some embodiments, a treatment plan may include mandibular advancement and while maintaining a gap 1586 between adjacent or non-adjacent teeth, such as for a missing or erupting tooth. The attachments 122 may also provide for tipping control, rotation, greater engagement with the aligner, and other benefits.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising”.

It will be understood that although the terms “first,” “second,” “third”, etc. may be used herein to describe various layers, elements, components, regions or sections without referring to any particular order or sequence of events. These terms are merely used to distinguish one layer, element, component, region or section from another layer, element, component, region or section. A first layer, element, component, region or section as described herein could be referred to as a second layer, element, component, region or section without departing from the teachings of the present disclosure.

As used herein, the term “or” is used inclusively to refer items in the alternative and in combination, unless indicated otherwise.

As used herein, characters such as numerals refer to like elements.

The present disclosure includes the following numbered clauses.

Clause 1. An orthodontic appliance comprising: a polymeric shell; a plurality of tooth receiving cavities formed in the polymeric shell that are shaped to move the teeth from a first arrangement towards a second arrangement; a first aligner feature at a first location on first of the tooth receiving cavities, the first aligner feature being a force generating feature configured to impart orthodontic tooth moving forces; and a second aligner feature stacked onto the first aligner feature at the first location on the first of the tooth receiving cavities.

Clause 2. The orthodontic appliance of clause 1, wherein the first aligner feature is an attachment receiving well, a button, a wing, an occlusal block, a power arm or a hook.

Clause 3. The orthodontic appliance of clause 2, wherein second aligner feature is an attachment receiving well, a button, a wing, an occlusal block, a hook, a power arm, or a compliance indicator.

Clause 4. The orthodontic appliance of clause 1, wherein second aligner feature is a force generating aligner feature.

Clause 5. The orthodontic appliance of clause 4, wherein the first aligner feature is an attachment receiving well, a button, a wing, an occlusal block, a power arm, or a hook.

Clause 6. The orthodontic appliance of clause 5, wherein second aligner feature is an attachment receiving well, a button, a wing, an occlusal block, a power arm, or a hook.

Clause 7. The orthodontic appliance of clause 1, wherein the first location is at a first occlusal-gingival height.

Clause 8. The orthodontic appliance of clause 1, wherein the first location is at a first mesial-distal location.

Clause 9. The orthodontic appliance of clause 1, wherein the first aligner feature at least partially overlaps the second aligner feature.

Clause 10. The orthodontic appliance of clause 1, wherein the first aligner feature is an attachment receiving well.

Clause 11. The orthodontic appliance of clause 10, wherein the second aligner feature is a button, a wing, an occlusal block, a hook, a power arm, or a compliance indicator.

Clause 12. The orthodontic appliance of clause 10, wherein the first and second aligner features are located on a buccal side of the attachment receiving well.

Clause 13. The orthodontic appliance of clause 10, wherein the first and second aligner features are located on a lingual side of the attachment receiving well.

Clause 14. The orthodontic appliance of clause 10, wherein the first and second aligner features are located on a occlusal surface of the attachment receiving well.

Clause 15. The orthodontic appliance of clause 1, further comprising a third aligner feature located at the first location on first of the tooth receiving cavities, the third aligner feature being a force generating feature.

Clause 16. An orthodontic appliance comprising: a polymeric shell; a plurality of tooth receiving cavities formed in the polymeric shell that are shaped to move the teeth from a first arrangement towards a second arrangement; an attachment receiving well at a first location first of the tooth receiving cavities and formed in an inner surface of the first of the tooth receiving cavities; and an externally extending aligner feature stacked at the first location on the first of the tooth receiving cavities and extending from an external surface of at the first location first of the tooth receiving cavities.

Clause 17. The orthodontic appliance of clause 16, wherein the externally extending aligner feature is a mandibular adjustment structure.

Clause 18. The orthodontic appliance of clause 16, wherein the externally extending aligner feature is an occlusal block.

Clause 19. The orthodontic appliance of clause 16, wherein the externally extending aligner feature is a buccal or lingual wing.

Clause 20. The orthodontic appliance of clause 16, wherein the externally extending aligner feature is a power arm.

Clause 21. An orthodontic appliance comprising: a polymeric shell configured to widen an arch of the patient by imparting an arch widening force in the buccal direction on the lingual surfaces of posterior teeth; a plurality of tooth receiving cavities formed in the polymeric shell that are shaped to move the teeth from a first arrangement towards a second arrangement; a protrusion extending form an inner surface of the first of the tooth receiving cavities into the first of the tooth receiving cavities at a first location first of the tooth receiving cavities and configured to impart an orthodontic force on the patient's detention at a location more occlusal than the arch widening force; and an externally extending aligner feature stacked at the first location on the first of the tooth receiving cavities and extending from an external surface of at the first location first of the tooth receiving cavities.

Clause 22. The orthodontic appliance of clause 21, wherein the externally extending aligner feature is a mandibular adjustment structure.

Clause 23. The orthodontic appliance of clause 21, wherein the externally extending aligner feature is an occlusal block.

Clause 24. The orthodontic appliance of clause 21, wherein the externally extending aligner feature is a buccal or lingual wing.

Clause 25. The orthodontic appliance of clause 21, wherein the externally extending aligner feature is a power arm.

Clause 26. A method of orthodontic treatment, the method comprising: receiving a digital model of a patient's dentition; generating a treatment plan comprising a plurality of treatment stages to incrementally move a patient's teeth from a first arrangement towards a second arrangement; and generating a digital model of an orthodontic appliance for a first of the plurality of stages of treatment, the digital model of the orthodontic appliances comprising: a polymeric shell; a plurality of tooth receiving cavities formed in the polymeric shell that are shaped to move the teeth from a first arrangement towards a second arrangement; a first aligner feature at a first location on first of the tooth receiving cavities, the first aligner feature being a force generating feature; and a second aligner feature stacked onto the first aligner feature at the first location on the first of the tooth receiving cavities.

Clause 27. The method of clause 26, wherein the first aligner feature is an attachment receiving well, a button, a wing, an occlusal block, a power arm or a hook.

Clause 28. The method of clause 27, wherein second aligner feature is an attachment receiving well, a button, a wing, an occlusal block, a hook, a power arm, or a compliance indicator.

Clause 29. The method of clause 26, wherein second aligner feature is a force generating aligner feature.

Clause 30. The method of clause 29, wherein the first aligner feature is an attachment receiving well, a button, a wing, an occlusal block, a power arm, or a hook.

Clause 31. The method of clause 30, wherein second aligner feature is an attachment receiving well, a button, a wing, an occlusal block, a power arm, or a hook.

Clause 32. The method of clause 26, wherein the first location is at a first occlusal-gingival height.

Clause 33. The method of clause 26, wherein the first location is at a first mesial-distal location.

Clause 34. The method of clause 26, wherein the first aligner feature at least partially overlaps the second aligner feature.

Clause 35. The method of clause 26, wherein the first aligner feature is an attachment receiving well.

Clause 36. The method of clause 35, wherein the second aligner feature is a button, a wing, an occlusal block, a hook, a power arm, or a compliance indicator.

Clause 37. The method of clause 35, wherein the first and second aligner features are located on a buccal side of the attachment receiving well.

Clause 38. The method of clause 35, wherein the first and second aligner features are located on a lingual side of the attachment receiving well.

Clause 39. The method of clause 35, wherein the first and second aligner features are located on an occlusal surface of the attachment receiving well.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. An orthodontic appliance comprising:
a polymeric shell;
a plurality of tooth receiving cavities formed in the polymeric shell that are shaped to move the teeth from a first arrangement towards a second arrangement;
a first aligner feature at a first location on first of the tooth receiving cavities, the first aligner feature being a force generating feature configured to impart orthodontic tooth moving forces; and
a second aligner feature stacked onto the first aligner feature at the first location on the first of the tooth receiving cavities.

2. The orthodontic appliance of claim 1, wherein the first aligner feature is an attachment receiving well, a button, a wing, an occlusal block, a power arm or a hook.

3. The orthodontic appliance of claim 2, wherein second aligner feature is an attachment receiving well, a button, a wing, an occlusal block, a hook, a power arm, or a compliance indicator.

4. The orthodontic appliance of claim 1, wherein second aligner feature is a force generating aligner feature.

5. The orthodontic appliance of claim 4, wherein the first aligner feature is an attachment receiving well, a button, a wing, an occlusal block, a power arm, or a hook.

6. The orthodontic appliance of claim 1, wherein the first aligner feature is an attachment receiving well.

7. The orthodontic appliance of claim 6, wherein the second aligner feature is a button, a wing, an occlusal block, a hook, a power arm, or a compliance indicator.

8. The orthodontic appliance of claim 6, wherein the first and second aligner features are located on a buccal side of the attachment receiving well.

9. The orthodontic appliance of claim 6, wherein the first and second aligner features are located on an occlusal surface of the attachment receiving well.

10. The orthodontic appliance of claim 1, further comprising a third aligner feature located at the first location on first of the tooth receiving cavities, the third aligner feature being a force generating feature.

11. An orthodontic appliance comprising:
a polymeric shell;
a plurality of tooth receiving cavities formed in the polymeric shell that are shaped to move the teeth from a first arrangement towards a second arrangement;
an attachment receiving well at a first location first of the tooth receiving cavities and formed in an inner surface of the first of the tooth receiving cavities; and
an externally extending aligner feature stacked at the first location on the first of the tooth receiving cavities and extending from an external surface of at the first location first of the tooth receiving cavities.

12. The orthodontic appliance of claim 11, wherein the externally extending aligner feature is a mandibular adjustment structure.

13. The orthodontic appliance of claim 11, wherein the externally extending aligner feature is an occlusal block.

14. The orthodontic appliance of claim 11, wherein the externally extending aligner feature is a buccal or lingual wing.

15. The orthodontic appliance of claim 11, wherein the externally extending aligner feature is a power arm.

16. An orthodontic appliance comprising:
a polymeric shell configured to widen an arch of the patient by imparting an arch widening force in the buccal direction on the lingual surfaces of posterior teeth;
a plurality of tooth receiving cavities formed in the polymeric shell that are shaped to move the teeth from a first arrangement towards a second arrangement;
a protrusion extending form an inner surface of the first of the tooth receiving cavities into the first of the tooth receiving cavities at a first location first of the tooth receiving cavities and configured to impart an orthodontic force on the patient's detention at a location more occlusal than the arch widening force; and
an externally extending aligner feature stacked at the first location on the first of the tooth receiving cavities and extending from an external surface of at the first location first of the tooth receiving cavities.

17. The orthodontic appliance of claim 16, wherein the externally extending aligner feature is a mandibular adjustment structure.

18. The orthodontic appliance of claim 16, wherein the externally extending aligner feature is an occlusal block.

19. The orthodontic appliance of claim 16, wherein the externally extending aligner feature is a buccal or lingual wing.

20. The orthodontic appliance of claim 16, wherein the externally extending aligner feature is a power arm.
